(19) United States
(12) Patent Application Publication
(10) Pub. No.: US 2012/0030597 A1
(43) Pub. Date: Feb. 2, 2012

(54) METHOD AND APPARATUS FOR CONTROLLING A WORKFLOW

(75) Inventors: Eric M. Circlaeys, Paris (FR); Kjell Bronder, San Francisco, CA (US)

(73) Assignee: Apple Inc., Patcupertino, CA (US)

(21) Appl. No.: 12/479,383

(22) Filed: Jun. 5, 2009

(51) Int. Cl. G06F 3/048

(52) U.S. Cl. 715/771

(57) ABSTRACT

The disclosure identifies a system and method for defining variable parameters to control a workflow. The control of the workflow is achieved in part through presentation and control of a user interface to a processor-based system that identifies variable parameters to the workflow and provides a mechanism by which such variable parameters may be input to the processing system. In some examples, only inputs of a subset of the variable parameters may be input at a single time. Similarly, in some examples, the system may control which variable parameters may be input at a given time in reference to prior inputs of other variable parameters.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyrights 2008, 2009 Apple® Inc. All Rights Reserved.

### BACKGROUND

The present invention relates generally to new methods and apparatus for controlling a workflow; and more specifically to use of a new interface to receive variable parameters regarding the workflow.

Many types of interfaces are known for interacting with various forms of processor-based systems, including, as just a few examples, computers of various types, cell phones, PDAs, etc. In many cases, such processing system interfaces will include a number of icons which may be selected to access specific programs or functionalities; or may include a number of screens through which data may be input. Examples of icon-based interfaces may be found in the OSX operating system offered by Apple Inc. of Cupertino, Calif.; and in various versions of the Windows operating system, offered by Microsoft Corporation of Redmond, Wash. Additionally, those familiar with web-based transactions will be familiar with interfaces that present a number of sequential screens for the input of information. Additionally, various types of interfaces are known for facilitating certain actions, such as troubleshooting or installation “wizards.” Typically, such “wizards” are implemented by a series of individually-displayed views within the same window space which does little or nothing to inform a user of the stage of the subject process the user may be performing. Additionally, such “wizards” do not control a workflow that may be implemented as a result of the provided inputs, but merely proceeds through a contemporaneous series of operations on the computer on which the inputs are provided.

As will be appreciated by those skilled in the art, with many conventional interfaces such as those discussed above, a user may still be required to have knowledge of what variables or other parameters need to be input in order for a given process to be implemented in a desired manner. For example, if a user of a computer system wishes to print a photograph, there are a number of potential variables that may need to be defined in order to establish a workflow yielding the intended printed output. Such variables may include, for example: the printer to be used, the size of the printed image, the paper or other material to be printed on, the orientation of the image on the paper, a color profile to be used, the number of images per page, etc. Once all variables are appropriately defined, then the workflow may be executed by the computer to yield the desired output on the desired printer. Yet some users may not always be aware of a need to select one or more of these variables to achieve an optimal printing output.

Accordingly, the present invention provides a new method and apparatus for managing such workflows through use of a graphical user interface configured to facilitate entry of all variables or other parameters needed for controlling the process to be performed.

### SUMMARY

The present invention provides an interface for receiving user inputs useful or necessary to control a workflow to be performed by a processor-based system, such as a computer. In preferred examples, a plurality of data input frames may be visually presented to a user, with each data input frame configured to receive one or more inputs of possible variable parameters to control the workflow. In these preferred examples, these input frames may be selected between active and inactive states, and input frames in an active state will be visually distinct from inactive frames. Additionally, in some examples of the invention, one or more inactive frames will be displayed adjacent an active frame.

### BRIEF DESCRIPTION OF THE FIGURES

FIG. 1A-J depicted a plurality of example screens displaying a further plurality of data input frames suitable for defining one type of workflow, as one example of the present invention.

FIG. 2 depicts an example of a summary screen view of the primary data input frames of FIGS. 1A-J.

FIG. 3 depicts an example flowchart of workflow processes that may be performed by a processing system in response to the definition of workflow variables such as may be defined through the example of FIGS. 1A-G.

FIG. 4 depicts an example processing system, in the form of a computing device, as may be used to perform one or more operations as described herein.

### DETAILED DESCRIPTION OF PREFERRED EMBODIMENTS

The following detailed description refers to the accompanying drawings that depict various details of embodiments selected to show, by example, how the present invention may be practiced. The discussion herein addresses various examples of the inventive subject matter at least partially in reference to these drawings and describes the depicted embodiments in sufficient detail to enable those skilled in the art to practice the invention. However, many other embodiments may be utilized for practicing the inventive subject matter, and many structural and operational changes in addition to those alternatives specifically discussed herein may be made without departing from the scope of the invented subject matter.

In this description, references to “one embodiment” or “an embodiment” mean that the feature being referred to is, or may be, included in at least one embodiment of the invention. Separate references to “an embodiment” or “one embodiment” in this description are not intended to refer necessarily to the same embodiment; however, neither are such embodiments mutually exclusive, unless so stated or as will be readily apparent to those of ordinary skill in the art having the benefit of this disclosure. Thus, the present invention can include a variety of combinations and/or integrations of the embodiments described herein, as well as further embodiments as defined within the scope of all claims based on this disclosure, as well as all legal equivalents of such claims.

For the purposes of this specification, a “processor-based system” or “processing system” includes a system using one or more processors, microcontrollers and/or digital signal processors having the capability of running a “program,” which is a set of executable machine code. A “program,” as used herein, includes user-level applications as well as system-directed applications or daemons. Processing systems include communication and electronic devices such as cell phones, music players, and Personal Digital Assistants (PDA); as well as computers, or “computing devices” of all forms (desktops, laptops, servers, palmtops, workstations, etc.).

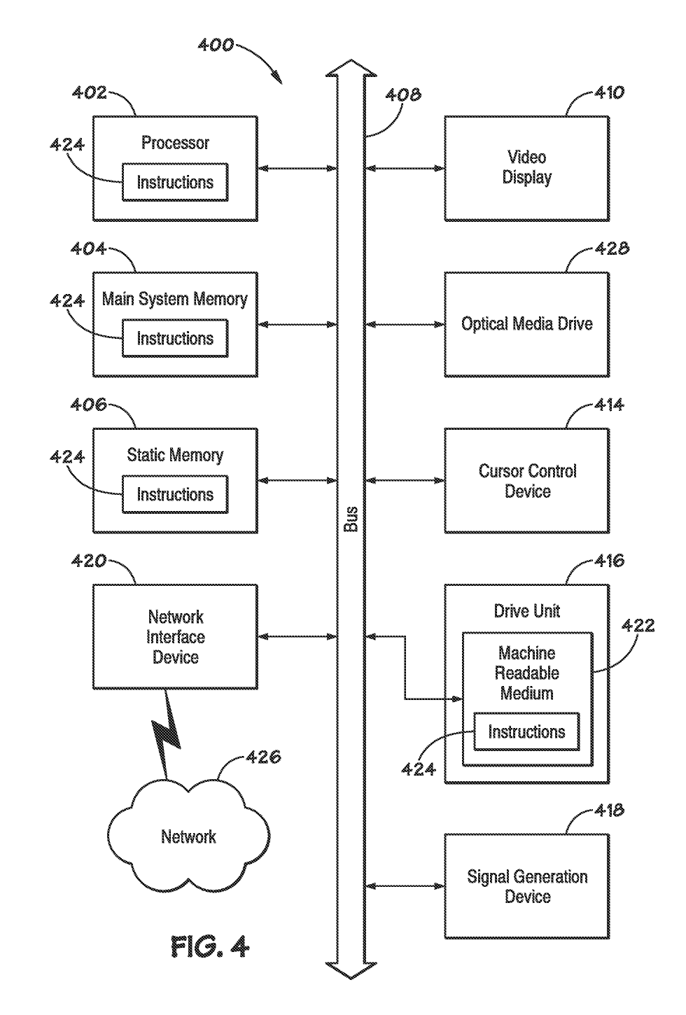

The examples of the invention provided herein will be discussed in reference to an embodiment on a computing device, such as the example device depicted in FIG. 4, and discussed in reference to such figure. Additionally, the provided examples will be in the context of a workflow to create a video product, such as a video podcast. As discussed in reference to FIG. 4, one example of such a computing device has a display, as well as a communication interface. As is known to those skilled in the art, the communication interface may be through various input devices, such as one or more of a mouse, keyboard, trackball, tablet, etc., or maybe through the display itself, such as through any of a number of types of “touch screen” interfaces. Additionally, a keyboard may either be a conventional electromechanical keyboard, or may be a virtual keyboard presented on the display, again for direct input through the display surface.

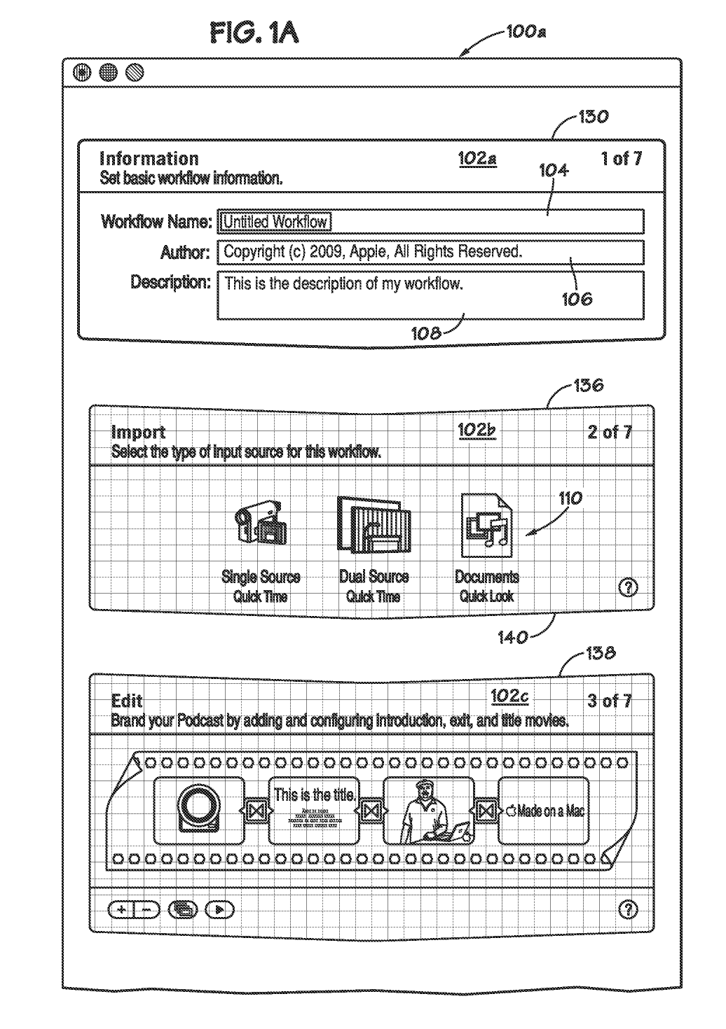

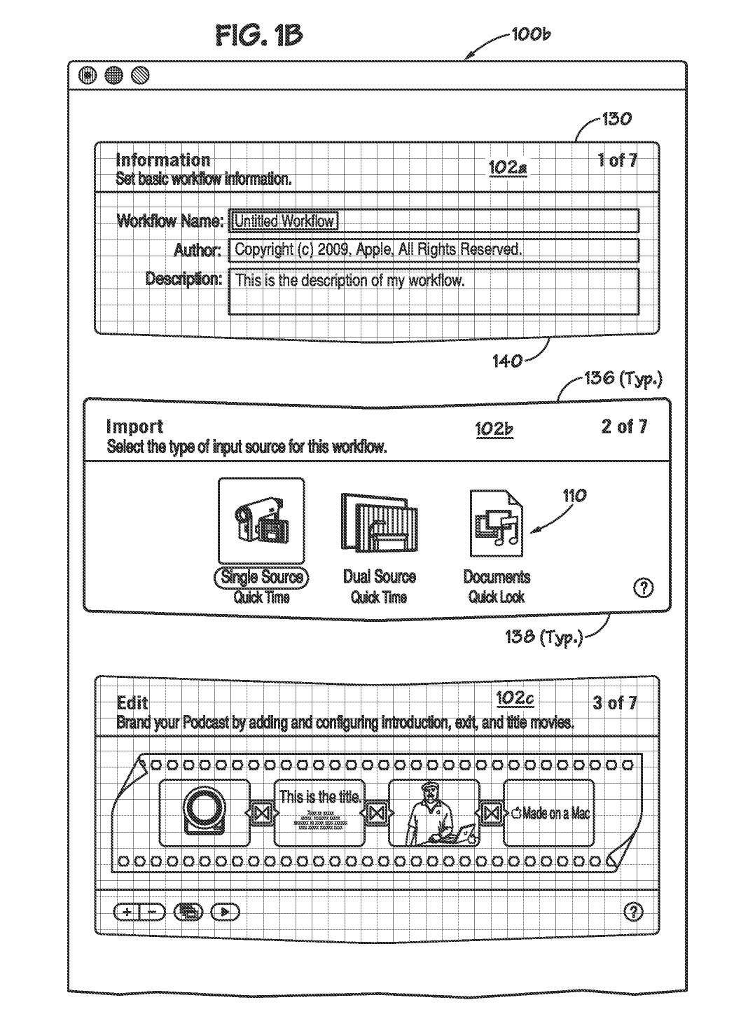

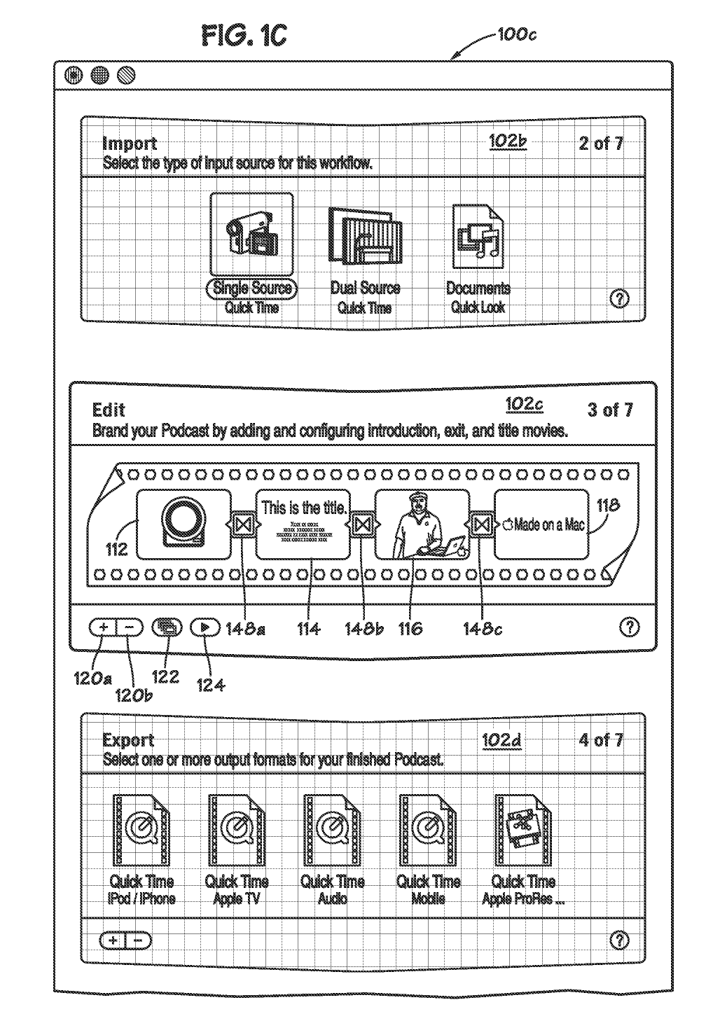

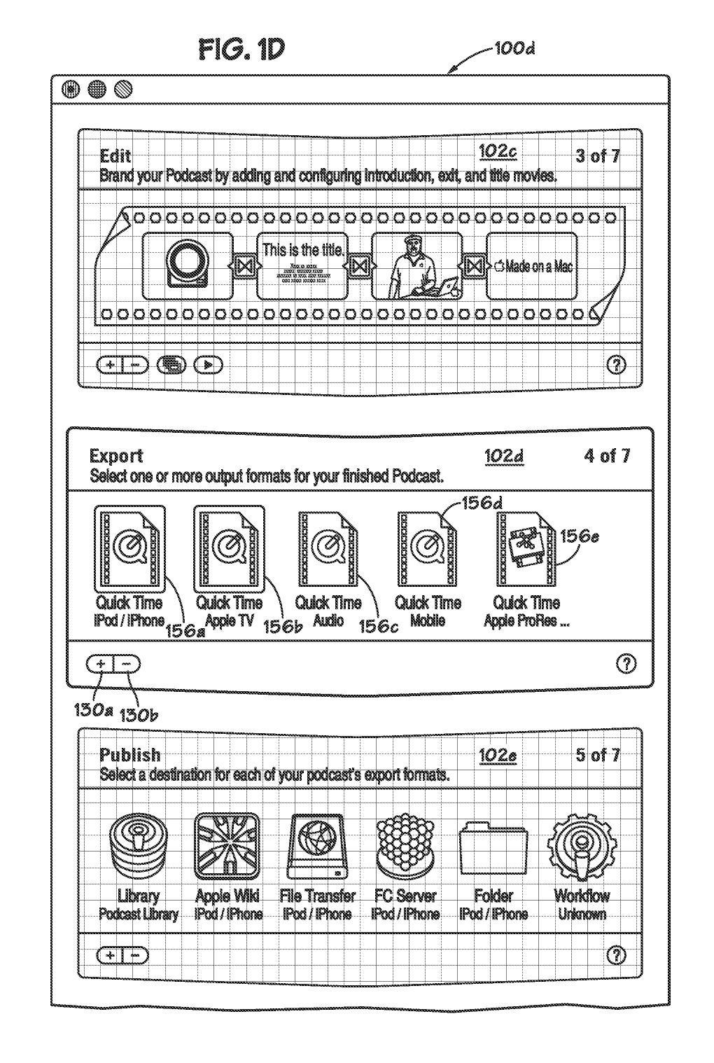

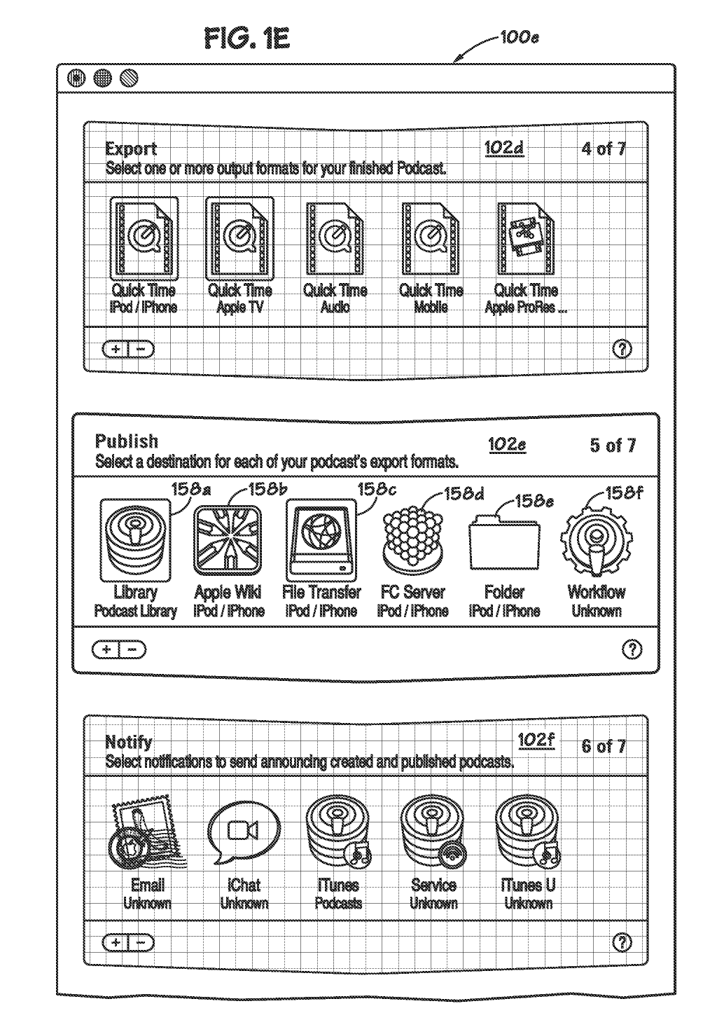

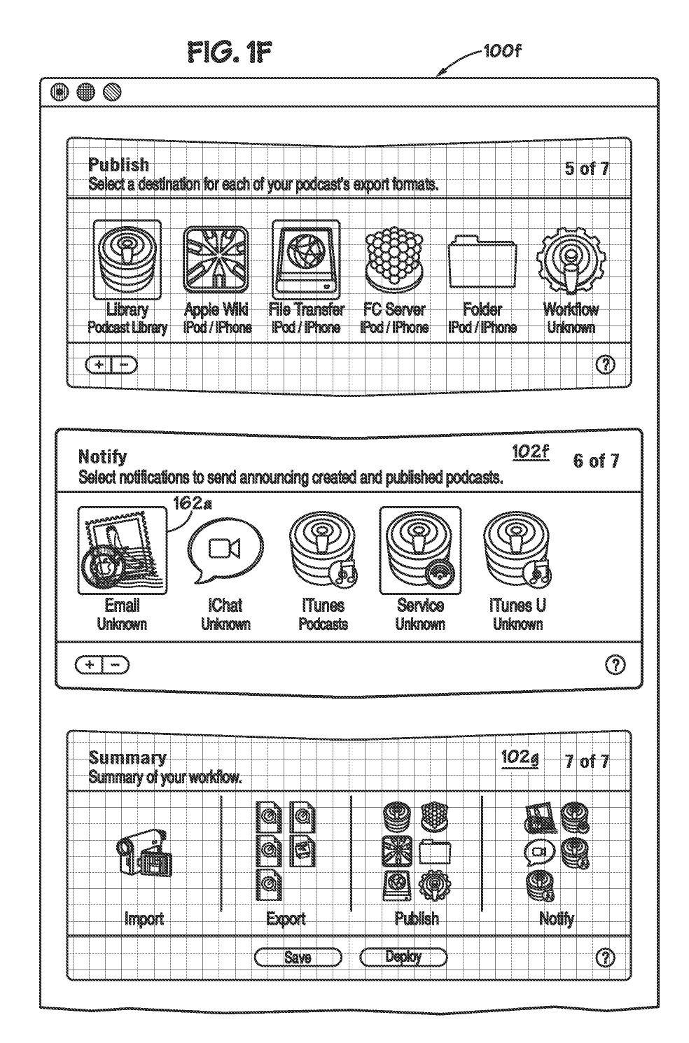

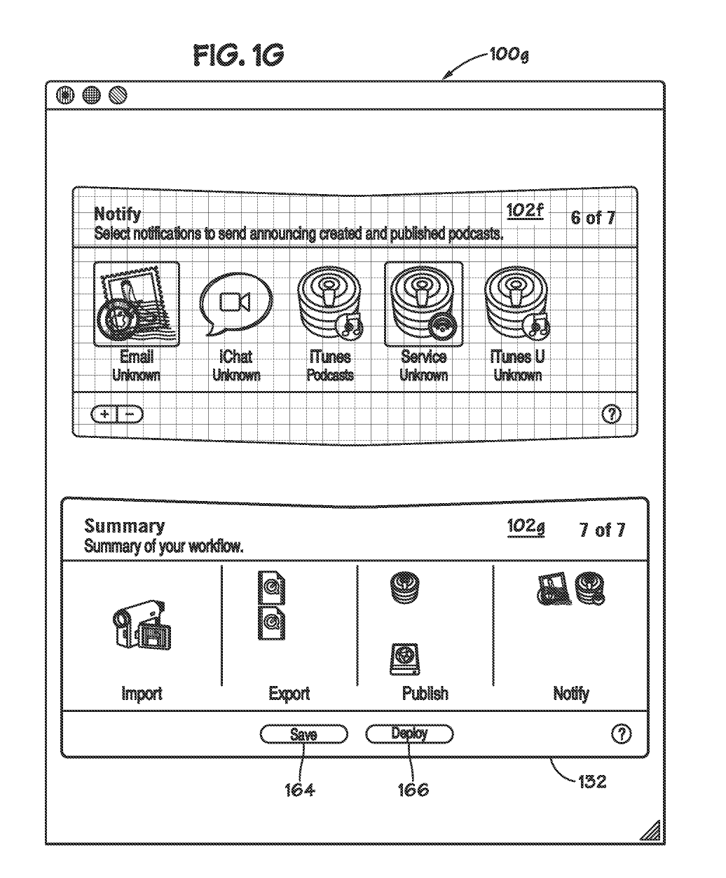

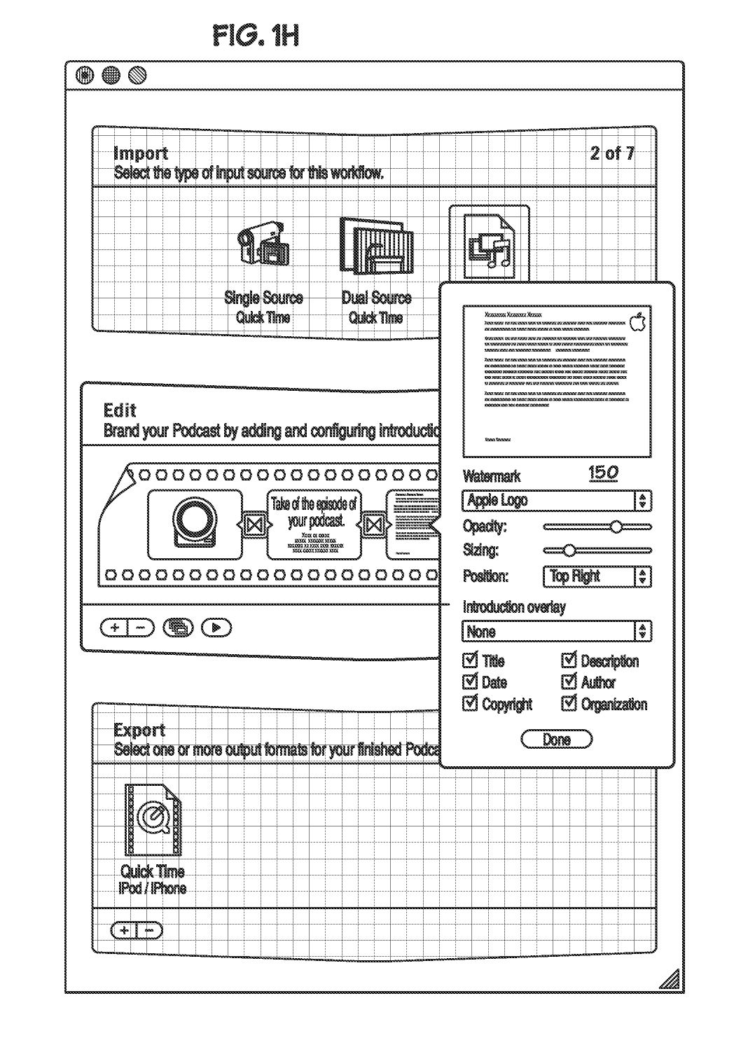

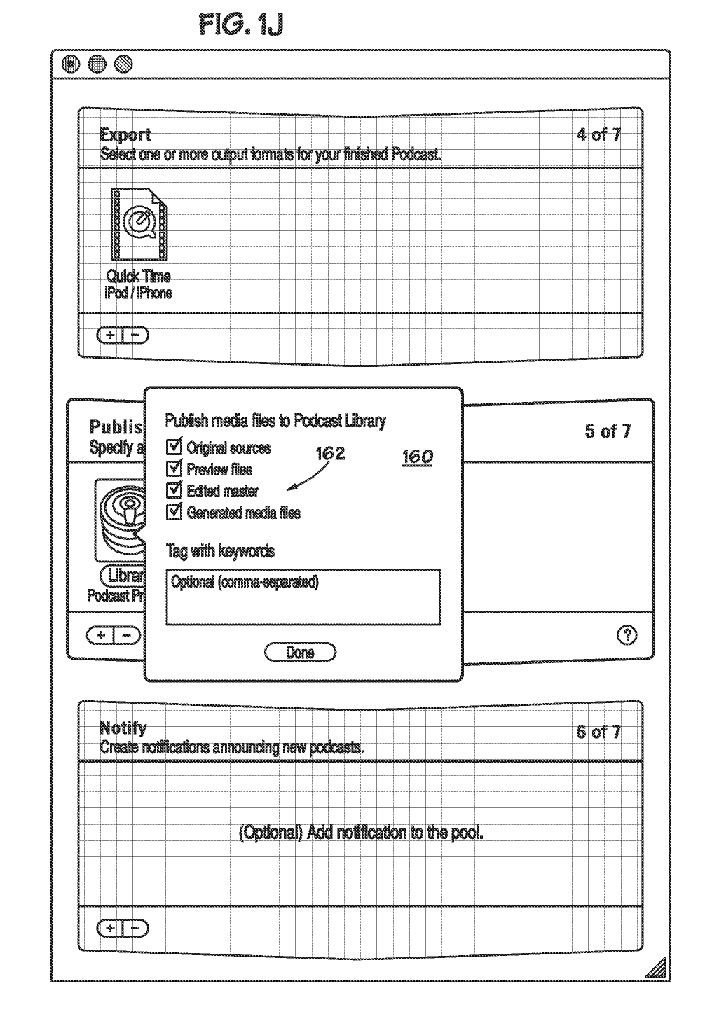

As used herein, the term “workflow” is intended to refer to any process to be performed through execution of machine-readable instructions wherein one or more variable parameters needs to be provided by a user, and where the process will be performed, at least substantially, subsequent to the providing of the variable parameters. In some cases, not every possible variable parameter will necessarily be provided, as the system may default to pre-determined variables in the absence of user inputs. The example of a workflow for printing an image was already discussed; and many more may be envisioned. Thus, a virtually infinite number of “workflows” might be envisioned for being controlled through use the techniques and structures described herein. Additionally, the “control” or “controlling” of a workflow is used herein to broadly to refer to the defining of the workflow to be performed (as discussed in reference to the example of FIGS. 1A-J), and/or to establishing parameters regarding the execution of an already-defined workflow.

Referring now to the drawings in more detail, and particularly to FIGS. 1A-J, therein are depicted a series of example display screens 100a-j that might be displayed to a user to facilitate defining a workflow to produce an audio or video podcast. The workflow defined through use of the example screens could be performed by a system such as that known as Podcast Producer, offered by Apple Inc. of Cupertino, Calif. Additionally such a workflow might be performed through use of a system such as that described in pending U.S. application Ser. No. 12/118,304, filed May 9, 2008, and assigned to Apple Inc.; and which is hereby incorporated herein by reference for all purposes. As another example, a workflow as addressed in the depicted examples might be run by a system such as that known a Podcast Producer available from Apple Inc. As will be apparent from the discussion to follow, the content of display screens 100a-j represent an abstraction of the workflow to be performed to facilitate obtaining of necessary or possibly useful variable parameters regarding the workflow. In this example, the display window will display a series of data input frames 102a-j, as discussed below. Thus display screens 100a-j depict the content of the display window over time, as the operation progresses.

As can be seen in FIG. 1A, screen 100a depicts three data input frames, 102a-c. The complete set of data input frames may be divided into as many individual frames as is deemed appropriate to clearly present the variables to be defined for the workflow, and may be constructed in any manner considered useful to facilitate entry of the variables by a user. In this example, the data input frames are separated into distinct data input frames 102a-j, with each data input frame separated from the others displayed in the window by a space, with each data input frame containing provision for inputs of one or more variable parameters directed to a specific function within the workflow. The data input frames are visually observable spaces for presentation to a user, to guide the user in entering the needed or desirable variable parameters to control the workflow. While data input through the data input frame is one desirable implementation, other configurations may be used, such as where the input frames facilitate input of the variables at one or more locations functionally associated with the frames, but separate from the frames that guide the user's input. In many examples, inputs of variable parameters will only be possible while a data input frame is active. As depicted in FIG. 1G, the data input frames may also be used to provide information to a user regarding a workflow, for example to provide a summary of the workflow based on variables provided by the user through use of other data input frames. In example data input frame 1G, the variable parameter is the decision to save or to deploy the workflow. Once the necessary variables are obtained, the executable instructions for controlling the workflow may be compiled in a manner known to those skilled in the art, such as through use of systems as identified above. The compiled workflow may then be used on the computer or other processing system where the variables were input, or it may be made accessible to one or more other processing systems to perform some or all of the defined processes.

As is apparent from FIG. 1A, data input frame 102a, is labeled “Information,” and provides a screen for providing identifying information regarding the workflow to be defined. In the example, data input frame 102a provides fields for entry of a workflow name 104, copyright information 106, and any other desired descriptive information 108. Other information could, of course, be solicited or provided for. In the example of data input frame 102a, the descriptive data is input as alpha-numeric data,

Referring now to FIG. 1B, data input frame 102b is labeled “Import” and provides a number of other choices of variables, indicated generally at 110, for selecting the type of input source to be used in the workflow. In this example, four possibilities are identified, including a single video, two videos, and one or more documents. It should be readily understood that these input sources are only examples that are pertinent to the example workflow of creating a video podcast. In that environment, one fundamental variable is the type of visual media data to be used. Other types of workflows may have completely different input variables. Additionally, while data input frame 102a provides for text entry for the identified variables; data input frame 102b provides for selection of the identified variables through icon selection. It should be clearly understood that any mechanism might be employed in the data input frames for inputting variables, such as, for example pull-down menus, “clickable” lists, etc. As will be shown below, in some examples, additional provisions may be made for facilitating additional inputs as to specific selections through the icons, such as through, for example, “pop-up” or “pull-down” menu structures, as known to those skilled in the art for data input.

Referring now to FIG. 1C, the depicted data input frame 102c is labeled “Edit” and provides for the defining of other variables for the video podcast workflow, including a first selected video for an opening image, indicated generally at 112, a title screen 114, the second selected video 116 (typically the main video presentation), and closing screen 118. In some examples, the title screen 114 may be generated in response to information input through data input frame 102a. Alternatively, the workflow definition may leave the title to be a parameter that a user/system can specify when initiating execution of the workflow. Similarly, closing screen 118 may also be a video clip. The closing screen video clip can, as one example, have a predefined content. Additionally, buttons are provided to add or subtract additional screens or fields 120a, 120b; to change the design theme for the workflow 122, and to preview 124 the defined workflow. In addition to the providing for the selection of the primary video and title component of the video podcast as identified above, the transitions between those components are identified with a block 148a-c, which enables input of variables for video transitions. Referring now also to FIG. 1H, as noted above, in some examples it will be useful to further define parameters regarding selected options. FIG. 1H depicts data input frame 102c, with an additional “pop-up” menu 150 selected in reference to the selected video 116. In this example, data input frame 102c may be considered to be a primary data input frame, and pop-up menu 150 may be considered a secondary data input frame. Such additional menus may be accessed, for example, either by a single or double mouse “click” on the icon of interest in the primary data input frame, in this example the icon for the selected video 116. As shown in this example, the pop-up menu may include, for example, instructions or information about the selection options and may also include further menus (in this case “pull-down” menus) to define other options. For example in the depicted pop-up menu 150 selection has been made to include a watermark with the video as a portion of the workflow. A feature of the example interface is that user inputs, such as selections, at one data input frame will often determine at least in part the options presented to a user in a subsequent data input frame. For example, if only “documents” had been selected as a source to be imported at data input frame 102b, then the options presented at “Edit” data input frame 102c would not, in at least many cases, include video editing options, and would include document-specific options.

Referring now to FIG. 1D, therein is depicted data input frame 102d, labeled “Export.” Data input frame 102d provides choices for the output format for the podcast to be created by the workflow. In the depicted example, options are provided by icons 156a-e, between different video Quicktime™ video formats, 156a, 156b, and 156d, and a Quicktime™ audio format 156c, with an additional option for processing by another program, in this example a compression and encoding application 156e, Compressor, also available from Apple Inc. Additionally, buttons are again provided 130a, 130b to add other potential formats or to delete any of these options.

Referring now to FIG. 1E, therein are depicted data input frames 102d, 102e and 102f, where “Publish” data input frame 102e is selected, and serves to enable selection of variables defining the destination for the defined podcast. In this example, icons for publishing to one or more selected servers, here a library server 158a and a remote file transfer server 158c have been selected as destinations for publishing of the podcast by the workflow. This stage also allows the user to define which and where the files generated at the previous stages, as for example in the Export stage, should be exported to. Referring now also to FIG. 1J, therein is depicted “Publish” data input frame 102e, with a secondary data input frame in the form of a pop-up menu 160 that has been actuated as described earlier herein. This pop-up menu provides items in a selectable list, indicated generally at 162, to identify which of the files generated by the workflow will be saved to the library; and also provides a space for text entry, in this example, keywords for tagging the published media files.

Referring now to FIG. 1F, data input frame 102f provides selection of one or more notification options when the workflow is completed. Selection of email icon 162a, may bring up another menu, as shown earlier herein, facilitating entry of an appropriate e-mail address. Alternatively, a record of a user's e-mail address might be a precondition for using the system and selection of e-mail notification might merely cause reference to that previously identified e-mail address. As a further alternative, the system might identify an email address in reference to other prior inputs to either the workflow definition or the running of the workflow itself.

Referring now also to FIG. 1G, therein is depicted data input frame 102g, entitled “Summary” which in this example does not present a variable selection to the user, but provides a summary of pertinent parameters of the workflow as defined through the previously entered variables. The summary of the previously selected or input variable parameters may be presented in virtually any desired format, including text, graphics, or any combination or other desired format. In the present example, which has been largely icon-based in terms of facilitating at least the high-level selections, the presentation of this summary presents the icons representative of the selections that were previously made in reference to “Import” data input frame 102b, “Export” data input frame 102d, “Publish” data input frame 102e and “Notify” data input frame 102f, as labeled. Options are then provided, through “clickable” buttons to either save the workflow configuration 164 or to deploy the workflow 166.

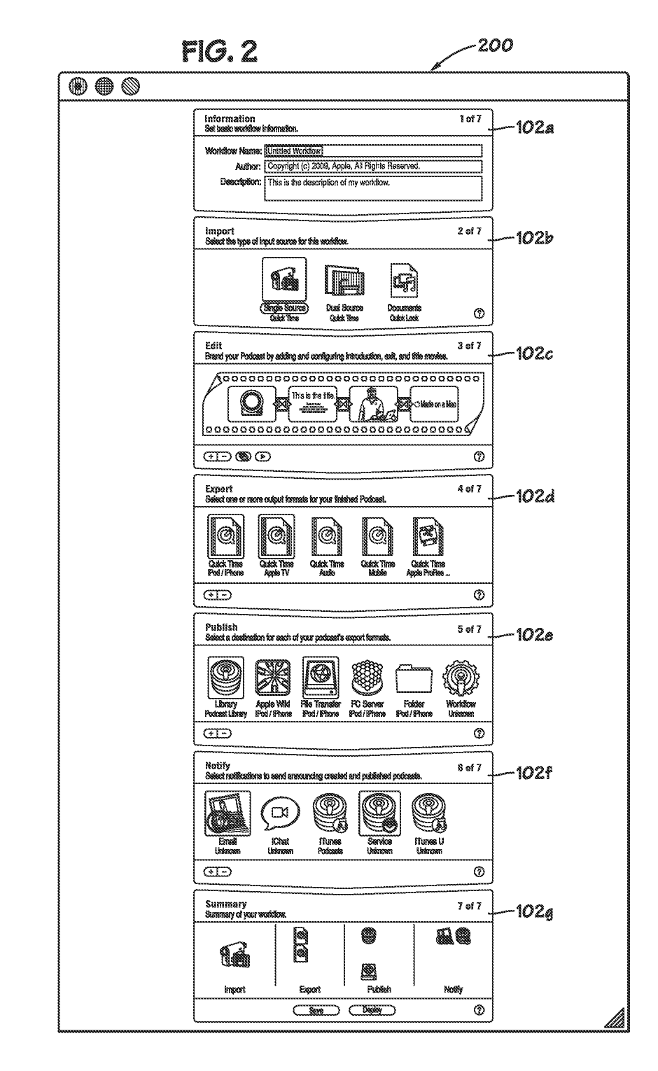

Referring again to screen 100a of FIG. 1A in general, it can be seen that the three data input frames 102a-c are generally vertically arranged, with the first data input frame 102a at the top of the window, and the third data input frame 102c at the bottom. In this screen, the first data input frame 102a, is the active data input frame for receiving input while data input frames 102b and 102c are inactive. The active status is identified to a user by a distinct appearance of data input frame 102a relative to the other displayed frames. In this example, this distinction may be found in differences in shading (depicted in the Figures as crosshatching over the image of the non-active data input frames), leaving data input frame 102a more prominently visible than adjacent screens 102b and 102c. Another variation that may be used, alone or in combination with other visual distinctions, is a difference in relative size between the active data input frame and the inactive data input frames. In the depicted example, that combination of these distinctions can be implemented to yield a three-dimensional effect, with the active data input frame 102a appearing closer to the user than the inactive data input frames 102b, 102c. This three-dimensional effect can be enhanced through use of shadow shading, so as to emphasize the effect. One other technique for showing the relation of the active data input frame to the inactive data input frames that is most apparent in FIGS. 1B-1G, is the maintaining of the active data input frame in a central position within the display window. Thus, the making of a data input frame active, whether by input device selection, keyboard shortcut, etc., may be accompanied by an animation, moving the displayed data input frames to place the active screen in a desired position, and also by an animation visually “moving” the selected screen outwardly, toward the user. As one example of an animation moving the screen positions, the screens may be scrolled in the appropriate direction as if they were on a continuous roll. Referring now also to FIG. 2, therein is shown an alternative view that is consistent with the presentation to a user of a simulation of the data input frames being on a continuous roll. FIG. 2 depicts a navigation screen 200 that may be presented a user to orient the user in the workflow-defining process and also, in some examples, to facilitate navigation by the user. In examples of such examples, selection of a data input frame, such as by clicking in the region of the screen be used within the system to direct the reader to the appropriate screen, such as one of 1A-G in the depicted workflow-defining example.

Referring to FIG. 1B it can been seen that inactive data input frame 102a includes a generally flat upper surface 130 but has a slight “V” or chevron shape at the lower surface 140, thereby providing a visual cue to a user that data input frame 102a is the uppermost screen, but that the workflow defining process proceeds downwardly through other data input frames. An opposite, complimentary, shape is applied to the last data input frame 102g (FIG. 1G), where bottom surface 132 is flat. In a similar way, data input frames 102b-f each have downwardly extending V-shaped contours on both upper surfaces 136 and lower surfaces 138, again providing a visual cue to the process. Those skilled in the art will recognize that other techniques or effects for drawing emphasis to the active data input frame may be utilized. Different examples of the invention contemplate placing emphasis on the active data input frame by changing one or more of the following characteristics: shading or coloration, size, shape, border appearance, relative placement, and orientation. Further, as the important difference is the relative appearance between the active data input frame and the inactive data input frames, such changes may be imposed on either of the selected, or active, data input frame or on the non-selected, inactive, data input frames.

Referring now to screen 100c of FIG. 1C, it can be seen that data input frame 102c has been made the active screen and therefore has an altered appearance relative to the remaining displayed input screens 102b and 102d. However, as identified above, in accordance with one preferred example of the invention, the making of data input frame 102c active has also resulted in reorientation of data input frame 102c to the center of the display window. Thus, in this example, relative to any active display window, at least some portions of the preceding data input frame and the following data input frame will be displayed. Similarly, as can be seen in screens 100d in FIG. 1D, and 100e in FIG. 1E, whenever a data input frame has been made active, that active data input frame (102d in FIG. 1D; and 102e in FIG. 1E), has been moved to the center of the display window. Of course, other desired orientations or placements might be utilized, such as always placing the active data input frame at the top of the display area.

Additionally, in the depicted example in FIGS. 1A-G, the display area has been utilized to display the preceding and following data input frames to the active screen; and thus not all data input frames may be displayed in the provided display area at one time. An alternative example of the invention, however, would be to display all, or at least a greater number of, input screens at whatever reduced size might be necessary; and to have a selected, or active, screen then made substantially larger than the inactive data input frames. The magnitude of such increase in size could be highly variable, depending upon the precise embodiment; for example increases in size of approximately 150% or more of the size of inactive data input frames could readily be envisioned. Additionally, in such an example, the inactive screens might be displayed in a relatively small size, but could temporarily magnify in response to a pointer, such as presence of a mouse pointer or a keyboard command to enable viewing by a user, while not actually selecting the data input frame to make it active.

The interface as depicted in FIGS. 1A-G, might be constructed as a static series of data input frames that would be used to define a audio or video podcast as described. However, it should be clearly understood that the displayed data input frames may also be dynamic, in that the number of the data input frames ultimately presented, and/or the content of one or more of those screens, may vary in response to previously entered variable inputs. As one example, in the described example in reference to data input frame 102b, the input source was selected to be a movie. However, as one example of a dynamic interface, if the selected input had been a slideshow as was presented as one option in data input frame 102b, then provision might be made for inputting an additional variable, for example selecting background music to play with the sideshow. Such provision could be made by a input screen that would appear within data input frame 102b on selection of the “Slideshow” option. Alternatively, a new data input frame (not depicted) might be presented in order to allow identification or selection of music, and possibly other parameters, such as adjusting the volume, tonal characteristics, etc.

Once a workflow control has been defined, such as the example defining of a video podcast workflow as described in reference to FIGS. 1A-G, then a processing system may take those variables defining the workflow and compile them with pre-existing executable instructions to establish a set of instructions executable to receive the appropriate data and to perform the workflow. These instructions may be generated either on the processing system, such as a computer, through which the selected variables were input; or they may be generated through use of a different processing system, such as a different computer. Additionally, the instructions may be actually executed (i.e., performing the workflow) on either the same or yet another processing system; and can in some cases be run over a computational grid, with tasks spread over the grid.

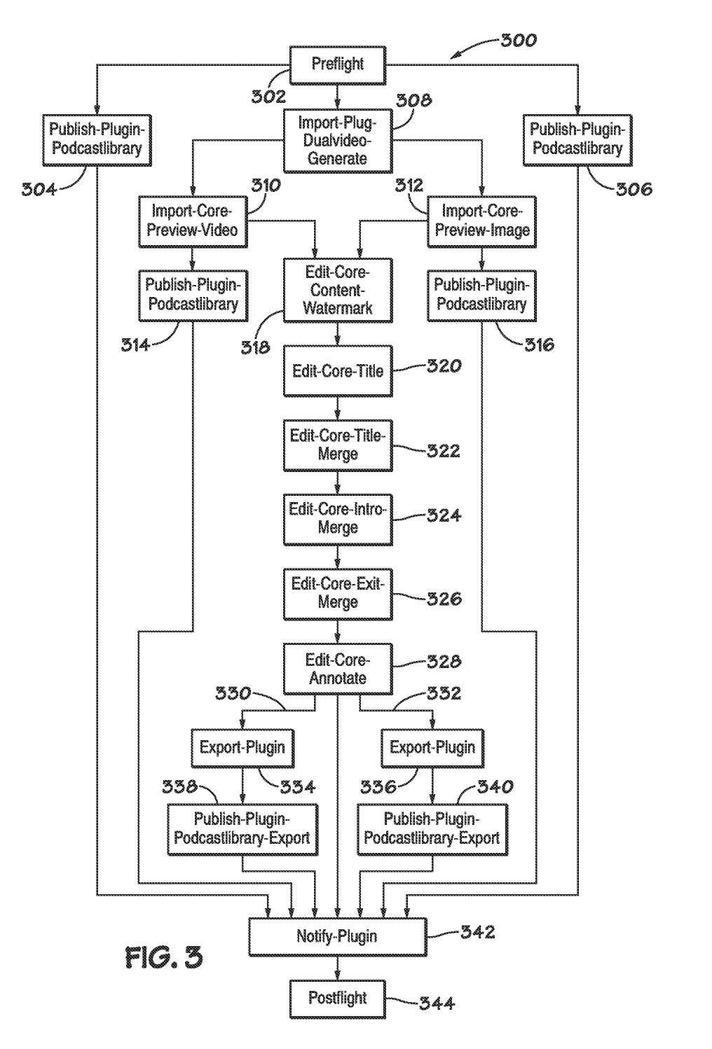

Referring now to FIG. 3, the Figure depicts a high-level flowchart 300 representative of a podcast generation workflow, that could be defined through use of the interface of FIGS. 1A-J in accordance with the variables established through data input frames 102a-f (though for purposes of illustration, the depicted workflow is not entirely in accordance with all variables selected in the discussed example of FIGS. 1A-J). As will be readily apparent to those skilled in the art, although the user interface of FIGS. 1A-J facilitates the providing of variables to define a specific workflow process, the components of the interface (in this example data input frames 102a-f), and the options presented through the interface are dictated by the underlying workflow. Thus, the steps that will be implemented to accept data from some source and to generate an output, in the present example a video podcast, will typically first be defined for any desired underlying workflow process, and an appropriate user interface will typically then be configured to provide the data input necessary to address or otherwise satisfy the variable parameters in the underlying workflow.

Flowchart 300 begins at a preflight stage 302, wherein data, such as in this case dual video streams have been captured and provided for processing in accordance with this example workflow. In the first instance, each original source video, as captured, will be “published,” or saved, to a podcast library at 304 and 306, respectively. In this example, the “raw” captured video data is published in its native format. This is an option that, in the example of FIGS. 1A-J was selectable by a user through pop-up menu 160, as depicted in FIG. 1J.

In accordance with options selected through “Import” data input frame 102b, the dual videos will be imported and combined to generate a single video, at step 308. One example of how this dual video format might be utilized is where one video of the source data is representative of a lecturer, for example, and the other video of the source data depicts a presentation, such as a Keynote™ presentation used by the lecturer. The import and generate dual video stage 308 and will combine the two video streams in a picture-in-picture video presentation. Subsequently, at preview-video step 310, a preview segment of the video stream will be created. Additionally, the workflow will generate a preview still image at step 312. Although each of these generated previews is an interim step in the workflow, they will again each be published to the podcast library at 314 and 316, respectively, if such was selected through an interface such as that depicted in FIG. 1J.

At step 318 a selected watermark may be added to the video, if selected. As discussed previously, an example of a pop up interface accessed through “Edit” data input frame 102c is depicted in FIG. 1H. Subsequently, at step 320, the video may be edited to add a title, and at step 322 to merge that title into the video. Any transitions selected through “Edit” data input frame 102c will also be incorporated into the video through the identified merging operations. Any introductory video, as described earlier herein, will then be merged into the video product at 324. And any defined exit to the video will be added to the video product at step 326, and any annotations that are desired and that were selected through “Edit” data input frame 102c will also be incorporated into the video product at step 328.

In the depicted example, the output of the editing stage will be provided at 330, 332 to the export stage for exporting the subject data at 334, 336 to the desired formats prior to publishing at 338, 340 to a podcast library server and to any other selected destinations. In addition, in this example workflow, the output of each “Publish” step 304, 306, 314, 316, 338, 340 will be used to trigger one or more notifications in accordance with the selections made through “Notify” data input frame 102f. Subsequent to such notifications, the workflow will terminate, at 344.

As is apparent from FIG. 4, each processing system implementing a workflow, either alone or in combination with other processing systems, will preferably be capable of communicating any necessary data or instructions through appropriate connections including network connections. FIG. 4 depicts a simplified block diagram of a machine in the example form of a processing system, such as a computing device, within which a set of instructions, for causing the machine to perform any one or more of the methodologies discussed herein, may be executed. In alternative embodiments, the machine may be connected (e.g., networked) to other machines. In a networked deployment, the machine may operate in the capacity of a server or a client machine in client-server network environment, or as a peer machine in a peer-to-peer (or distributed) network environment. While only a single machine is illustrated, the term “machine” shall also be taken to include any collection of machines that individually or jointly execute a set (or multiple sets) of instructions to perform any one or more of the methodologies discussed herein.

Example computing device 400 includes processor 402 (e.g., a central processing unit (CPU), a graphics processing unit (GPU) or both), main system memory 404 and static memory 406, which communicate with each other via bus 408. Computing device 200 may further include video display unit 410 (e.g., a plasma display, a Liquid Crystal Display (LCD), Organic Light Emitting Diode (OLED) display, Thin Film Transistor (TFT) display, or a cathode ray tube (CRT)). Computing device 400 also includes optical media drive 104, user interface (UI) navigation device 414 (e.g., a mouse), disk drive unit 416, signal generation device 418 (e.g., a speaker), optical media drive 428, and network interface device 420.

Disk drive unit 416 includes machine-readable medium 422 on which is stored one or more sets of instructions and data structures (e.g., software 424) embodying or utilized by any one or more of the methodologies or functions described herein. Software 424 may also reside, completely or at least partially, within main system memory 404 and/or within processor 402 during execution thereof by computing device 200, with main system memory 404 and processor 402 also constituting machine-readable, tangible media. Software 424 may further be transmitted or received over network 426 via network interface device 420 utilizing any one of a number of well-known transfer protocols (e.g., Hypertext Transfer Protocol (HTTP)).

While machine-readable medium 422 is shown in an example embodiment to be a single medium, the term “machine-readable medium” should be taken to include a single medium or multiple media (e.g., a centralized or distributed database, and/or associated caches) that store the one or more sets of instructions. The term “machine-readable medium” shall also be taken to include any medium that is capable of storing or encoding a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and other structures facilitating reading of data stored or otherwise retained thereon.

Many modifications and variations may be made to the techniques and structures described and illustrated herein without departing from the scope of the present invention. For example, as referenced above many types of variations might be implemented to guide a user through a series of input frames, such as the depicted data input frames. As one example, completion of input of variables in one input frame, might cause automatic inactivation of that input frame and activation of a subsequent input frame. Additionally, although specification has addressed primarily the use of visual cues to guide a user through the process of providing the necessary variables, these visual cues could be used in conjunction with, for example, audible tones. Accordingly, the present specification must be understood to provide examples to illustrate the present inventive concepts and to enable others to make and use those inventive concepts.

We claim:

1. A method for facilitating user input to control a workflow, comprising the acts of:
using a processor to perform operations comprising generating signals representative of a display for presentation to the user, the display comprising a plurality of data input frames, each data input frame associated with at least one mechanism for the entry of a variable parameter for the workflow; and
receiving a user input to the processing system, and in response to the input placing one data input frame of the plurality of data input frames in an active state in which entry of at least one variable parameter is permitted; and
generating signals representative of a display for presentation to the user wherein the display indicates the active state of one data input frame to the user through a distinguishing visual appearance of the active data input frame relative to another displayed data input frame.

2. The method of claim 1, wherein the generated display comprises at least one active data input frame and at least a portion of an inactive data input frame.

3. The method of claim 1, wherein the at least one mechanism for the entry of a variable parameter for the workflow is selected from the group consisting essentially of a text field, a pull-down menu, a pop-up menu and a selectable icon.

4. A method for facilitating user input to a processing system to control a workflow, comprising the acts of
through use of a processor-based system having a display, visually displaying a plurality of data input frames to the user, with each data input frame providing a respective field for the entry of at least one variable parameter for the workflow; and
placing a first data input frame of the plurality of data input frames in an active state wherein entry of the at least one variable parameter is permitted, and indicating the active state of the first data input frame to the user by altering the visual appearance of the first data input frame relative to another displayed data input frame.

5. The method of claim 4, wherein the act of indicating the active state of the data input frame to the user by altering the visual appearance of the active input frame comprises altering at least one visual parameter of the active data input frame, the visual parameter selected from the group consisting essentially of shading, size, shape, border appearance, relative placement, and orientation.

6. The method of claim 4, further comprising the acts of:
receiving inputs of at least one variable parameter at each of the plurality of input frames; and
providing control instructions in reference to the received inputs of variable parameters, the control instructions executable to control a workflow.

7. The method of claim 6, wherein the control instructions are executed on the same processing system through which the variable parameter inputs were received.

8. The method of claim 6, wherein the control instructions are communicated to a different processing system than that through which the variable parameter inputs were received.

9. A method of defining a workflow, comprising the acts of:
identifying at least one data source to the workflow, and identifying a plurality of variable-based operations that may be performed within the workflow;
establishing a plurality of data input frames to identify options for at least a portion of the variable-based operations within the workflow;
providing an input mechanism associated with each data input frame to receive an input from a user as to at least one variable;
displaying first and second data input frames to a user, with the first data input frame being active to enable a first set of one or more user inputs;
receiving a first set of one or more user inputs in reference to the first data input frame;
in response to the user inputs received in reference to the first data input frame, making the first data input frame inactive to enable further user input, and making a second data input frame active to enable a second set of one or more user inputs.

10. The method of defining a workflow of claim 9, wherein the act of displaying the first and second data input frames to a user comprises displaying an active user frame with an appearance visually distinct from the appearance of an inactive user frame.

11. The method of defining a workflow of claim 9, wherein each of the plurality of data input frames is a primary data input frame, and wherein at least one of the data input frames provides a link to a secondary data input frame.

12. The method of claim 11, wherein the secondary data input frame is displayed to a user is response to a user input in an associated primary data input frame.

13. The method of claim 13, wherein the displayed secondary data input frame is comprises a pop-up window.

14. The method of defining a workflow of claim 9, wherein each of the plurality of data input frames is a primary data input frame, and wherein the method further comprises the act of displaying all data input frames of the plurality of data input frames simultaneously.

15. A machine readable medium bearing instructions that, when executed by one or more processors, perform operations comprising:
generating signals representative of a display for presentation to the user, the display comprising a plurality of data input frames, each data input frame providing at least one option for the entry of a variable parameter for the workflow; and
placing a first data input frame of the plurality of data input frames in an active state in which entry of the at least one variable parameter is permitted, and generating signals representative of a display for presentation to the user wherein the display indicates the active state of the first data input frame to the user through a visually distinct appearance of the first data input frame relative to other displayed data input frames.

16. The machine readable medium of claim 15, wherein the display comprises the active data input frame and at least a portion of at least one inactive data input frame.

17. The machine readable medium of claim 16, wherein the visually distinct appearance of the first data input frame relative to other displayed data input frames is based on a difference of at least one parameter selected from the group consisting essentially of shading, size, shape, border appearance, relative placement, and orientation of the active input frame relative to the other displayed input frames.

18. The machine readable medium of claim 16 wherein each of the plurality of data input frames is a primary data input frame, and wherein at least one of the primary data input frames provides a link to an associated secondary data input frame.

19. The machine readable medium of claim 18, wherein the secondary data input frame is displayed to a user in response to a user input in the associated primary data input frame.

20. The machine readable medium of claim 15, wherein the performed operations further comprise:
receiving a user input through the first data input frame for the at least one option for entry of a variable parameter through that data input frame; and
determining the content for a second data input frame in reference to the received user input through the first data input frame;
placing the first data input frame in an inactive state; and
presenting the second data input frame in an active state, the second data input frame displaying the content determined in reference to the received user input through the first data input frame.

21. A method of claim 4, further comprising the acts of:
receiving a user input through the first data input frame for the at least one option for entry of a variable parameter through that data input frame; and
determining the content for a second data input frame in reference to the received user input through the first data input frame;
placing the first data input frame in an inactive state; and
presenting the second data input frame in an active state, the second data input frame displaying the content determined in reference to the received user input through the first data input frame.
